(19) United States
(12) Patent Application Publication
(10) Pub. No.: US 2010/0027468 A1
(43) Pub. Date: Feb. 4, 2010

(54) Method and system for managing core network information

(75) Inventors: Rajavelsamy Rajadurai, Bangalore (IN); Jicheol Lee, Gyeonggi-do (KR); Hanna Lim, Gyeonggi-do (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/462,256

(22) Filed: Jul. 30, 2009

(30) Foreign Application Priority Data
Jul. 30, 2008 (IN) 1833/CHE/2008

(51) Int. Cl. H04W 8/02

(52) U.S. Cl. 370/328

(57) ABSTRACT

A method and system for managing information of a plurality of core networks associated with a network access provider is provided. The method includes identifying a core network type of each core network of the plurality of core networks. The method also includes broadcasting the core network type of each core network of the plurality of core networks along with a network identity of each core network.

### CROSS-REFERENCE TO RELATED APPLICATION(S) AND CLAIM OF PRIORITY

The present application is related to and claims priority under 35 U.S.C. §119 to an application filed in the Indian Intellectual Property Office on Jul. 30, 2008 and assigned Serial No. 1833/CHE/2008, the contents of which are incorporated herein by reference.

### TECHNICAL FIELD OF THE INVENTION

The present invention relates to managing information in a communication network. More particularly, the present invention relates to managing core network information in communication networks.

### BACKGROUND OF THE INVENTION

Over a period of time, technology associated with communication networks has evolved significantly. Today, Network Access Provider (NAP), for example a WiMAX access network, has a provision of network sharing. Hence, one or more Network Service Providers (NSPs) are associated with one Radio Access Network (RAN) provided by the Network Access Provider (NAP). Thus, one or more NSPs (core networks) can share the WiMAX access network simultaneously for enabling communication between a plurality of mobile stations.

The one or more NSPs can be associated with the same or different communication protocols based on a core network type. Examples of core network types include WiMAX network, EPC network, High Rate Packet Data (HRPD) network, and the like. Further, each of the plurality of mobile stations uses one or more communication protocols associated with one or more core network types for enabling communication with other mobile stations or with other services. Therefore, each mobile station can access one or more NSPs (core networks) using the NAP for establishing communication with other mobile station or with other services.

Hence, the NAP allows a plurality of Mobile Stations (MSs) to communicate with each other by allowing each MS to access at least one core network associated with the NAP. For example, a first mobile station that is a WiMAX terminal can use a WiMAX core network from a plurality of core networks that is associated with the NAP. For this, the NAP initially broadcasts or unicasts a list of core networks associated with the NAP. Hence, a mobile station receives a list of core networks from the NAP. The MS then performs a trial and error method to identify a preferred core network from the list of core networks. Thereafter, the MS can select the identified core network for enabling communication.

Further, an MS during roaming has to select a preferred visited core network when the MS visits a particular area. Then, the MS performs a trial and error method and tries all NSPs (core networks) associated with a NAP for recognizing the visited and preferred core network type. Thereafter, the MS selects a preferred core network.

Hence there exists a need to efficiently manage core network type information in a wireless communication network.

### SUMMARY OF THE INVENTION

To address the above-discussed deficiencies of the prior art, it is a primary object to provide a method for managing information of a plurality of core networks is provided. The plurality of core networks is associated with a Network Access Provider (NAP). The method includes identifying a core network type of each core network from the plurality of core networks. The method also includes broadcasting the core network type information of each core network from the plurality of core networks along with a network identity of each core network.

In another embodiment, a method for managing information of a plurality of core networks is provided. The plurality of core networks is associated with a network access provider. The method is performed at a Mobile Station (MS). The method includes storing core network type information of each core network from the plurality of core networks in a memory. The memory is associated with the MS. The method also includes selecting a core network based on the core network type of the plurality of core networks.

In yet another embodiment, a method for managing information of a plurality of core networks is provided. The plurality of core networks is associated with a network access provider. The method is performed at a Mobile Station (MS). The method includes storing a core network type of each core network from the plurality of core networks in a Subscriber Identification Module (SIM) card. The SIM card is associated with the MS. The method also includes selecting a core network based on the core network type of the plurality of core networks.

In an embodiment, a method for managing information of a plurality of core networks is provided. The plurality of core networks is associated with a Network Access Provider (NAP). The method includes identifying a core network type of each core network from the plurality of core networks. The method also includes unicasting the core network type information of each core network from the plurality of core networks in at least one of a core network realm part, a network authentication message, an SS Basic Capability Response (SBC-RSP) message, an Advanced Air Interface SS Basic Capability Response (AAI_SBC-RSP) message, a corresponding message in IEEE 802.16m standard, an OTA message to configure and update the mobile's preferred core network list and a Handover (HO) command message.

In still another embodiment, a method for managing information of a plurality of core networks associated with a network access provider is provided. The method is performed at a mobile station. The method includes receiving information associated with a core network type of each core network from the plurality of core networks. The method also includes selecting a core network from the plurality of core networks for enabling communication based on the received information associated with the core network type of each core network and a preferred core network type information that is associated with the mobile station.

In still another embodiment, a network access provider is provided. The network access provider includes a processor configured to identify a core network type of each core network from the plurality of core networks associated with the network access provider. The network access provider also includes a transceiver configured to transmit the core network type of each core network from the plurality of core networks along with a network identity of each core network.

In still another embodiment, a mobile station is provided. The mobile station includes a memory configured to store a core network type of each core network from the plurality of core networks. The mobile station also includes a processor configured to select a core network based on the core network type of the plurality of core networks stored in the memory.

The features and advantages of the present invention will become more apparent from the ensuing detailed description of the invention taken in conjunction with the accompanying drawings.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary environment where various embodiments of the present invention can be practiced;

FIG. 2 illustrates a network access provider in accordance with one embodiment of the present invention;

FIG. 3 illustrates a mobile station in accordance with one embodiment of the present invention;

FIG. 4 illustrates a flow chart depicting a method of managing information associated with a plurality of core networks associated with a network access provider in accordance with one embodiment of the present invention;

FIG. 5 illustrates an exemplary format for storing information associated with core networks in accordance with one embodiment of the present invention;

FIG. 6 illustrates an exemplary assignment of operator identity (OID) in one embodiment of the present invention; and

FIGS. 7A and 7B illustrate a call flow diagram representing a method of sending core network type information in accordance with one embodiment of the present invention.

Persons skilled in the art will appreciate that elements in the figure is illustrated for simplicity and clarity and may have not been drawn to scale. For example, the dimensions of some of the elements in the figure may be exaggerated relative to other elements to help to improve understanding of various embodiments of the present disclosure.

### DETAILED DESCRIPTION OF THE INVENTION

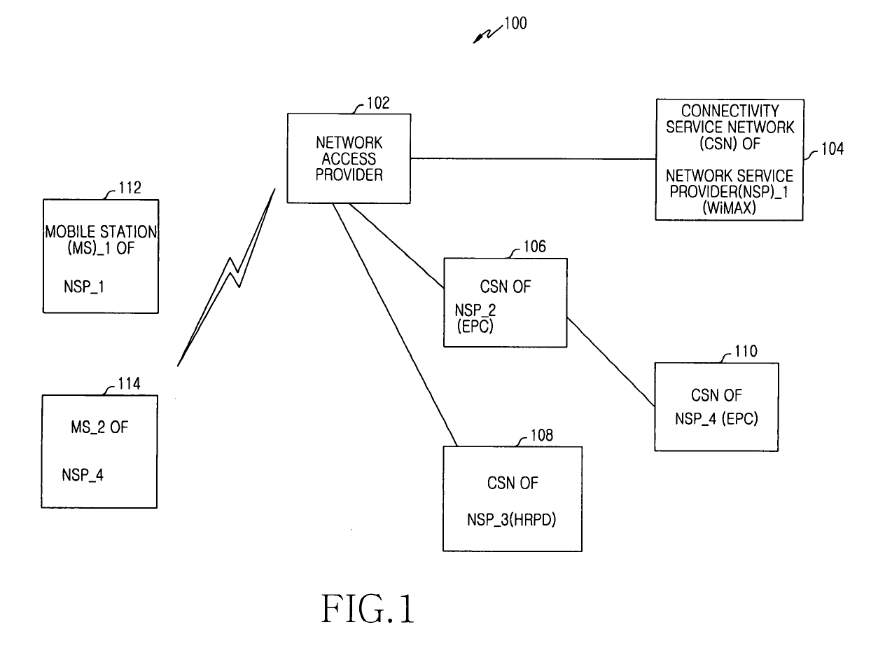

FIGS. 1 through 7B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are no where intended to represent a chronological order, as and where stated otherwise. A set is defined as a non-empty set including at least one element.

FIG. 1 illustrates an exemplary environment 100 where various embodiments of the present invention can be practiced. The environment 100 includes a Network Access Provider (NAP), a plurality of core networks (Network Service Providers (NSPs)) associated with the NAP, and a plurality of mobile stations. For example, the environment 100 includes a NAP 102 and four NSPs (core networks) associated with the NAP 102. In an embodiment, the NAP 102 is a WiMAX access network. The four NSPs (core networks) include an NSP 104, an NSP 106, an NSP 108 and an NSP 110. The environment 100 also includes two Mobile Stations (MSs), for example an MS 112 and an MS 114. However, while only one NAP, four NSPs, and two MSs are shown in the environment 100, it will be apparent to the person ordinary skilled in the art that the environment 100 includes more than one NAP and more or less numbers of NSPs and MSs.

For the purpose of this description and for the sake of clarity the terms NSPs and core networks will be used interchangeably. Each of the different core networks is associated with a core network type. For example, the NSP 104 (NSP_1) is a WiMAX network, the NSP 106 (NSP_2) is associated with an Evolved Packet Core (EPC) network, the NSP 108 (NSP_3) is associated with a High Rate Packet Data (HRPD) network and the NSP 110 (NSP_4) is associated with an Evolved Packet Core (EPC). Hence, the NAP 102 is shared by different core networks. In the environment 100, the mobile station 112 (MS_1) is associated with the NSP 104 (NSP_1) and the mobile station 114 (MS_2) is associated with the NSP 110 (NSP_4).

For enabling communication, the NAP 102 will allow mobile stations to access a core network from the plurality of core networks that are sharing the NAP 102. For example, the NAP 102 allows the mobile station 114 to access the core network EPC of the NSP 110. In the environment 100, the NAP 102 broadcasts or unicasts a core network type of each core network associated with the NAP 102 (WiMAX access network).

The MSs, for example MS 112 and 114, can then identify the core network type of each core network available and can select the core network based on core network type preference. In an embodiment, the MSs receive the broadcasted or unicasted core network type information associated each of the core networks. Further, the MSs can select a core network from the plurality of core networks based on a preferred core network type.

Also, when an MS accesses the NAP 102 during roaming, the MS recognizes a core network type of a visited network based on the core network type information that is broadcasted or unicasted by the NAP 102. Therefore, the MS can select a core network based on a preferred core network type. For example, the NAP 102 will broadcast a list of NSPs along with their corresponding core network type information. Hence, the NAP 102 will broadcast that NSP_1 is a WiMAX network, NSP_2 is an EPC network, NSP_3 is an HRPD network, and NSP_4 is an EPC network. Thereby, an MS, for example the MS 112, can select NSP_1 if the MS 112 preference is a WiMAX network type.

In an embodiment, a core network type of each core network from the plurality of core networks is stored in a memory of the MS. In another embodiment, a core network type of each core network from the plurality of core networks is stored in a Subscriber Identification Module (SIM) card associated with the MS. Hence, a core network can be selected from the plurality of core networks stored in the memory and/or SIM card.

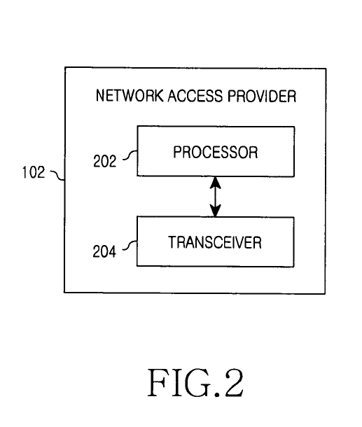

FIG. 2 illustrates a network access provider in accordance with one embodiment of the present invention. To explain the network access provider, references will be made to FIG. 1. However, it will be apparent to a person ordinarily skilled in the art that the present embodiment can be explained with the help of any other suitable embodiment of the present invention. The Network Access Provider (NAP) 102 includes a processor 202 and a transceiver 204.

The processor 202 identifies a core network type of each core network from a plurality of core networks associated with the NAP. For example, the processor 202 in the NAP 102 identifies a core network type of the core network, for example the core network type of each of the NSP 104, the NSP 106, the NSP 108 and the NSP 110.

The transceiver 204 in the NAP 102 then broadcasts the core network type of each core network from the plurality of core networks along with a network identity of each core network. In an embodiment, the transceiver 204 unicasts the core network type of each core network from the plurality of core networks. Hence, the core network type of each core network can be received by the MS. Thereafter, the MS can associate with the preferred core networks based on the core network type information received and the preferred core network type.

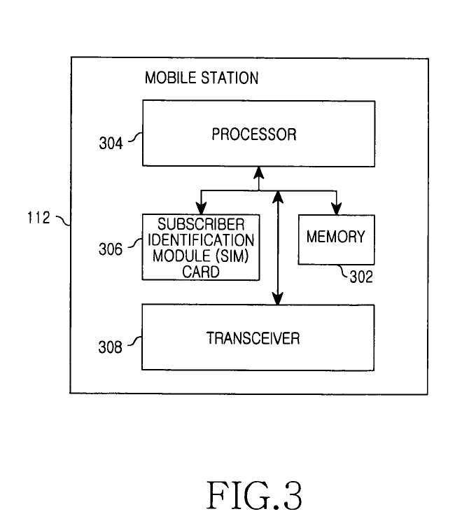

FIG. 3 illustrates a mobile station, in accordance with one embodiment of the present invention. To explain the mobile station, references will be made to FIG. 1. However, it will be apparent to a person ordinarily skilled in the art that the present embodiment can be explained with the help of any other suitable embodiment of the present invention. The Mobile Station (MS) 112 includes a memory 302 and a processor 304.

The memory 302 stores core network type information of each core network from the plurality of core networks in a memory associated with the MS. In an embodiment, the memory 302 of the MS 112 will store the core network type of each core network. For example, core network types of the NSP 104, the NSP 106, the NSP 108 and the NSP 110 is stored in the memory 302 of the mobile station 112.

Thereafter, the processor 304 in the mobile station 112 selects a core network based on the core network type of the plurality of core networks stored in the memory 302. For example, when the MS 112 wants to connect to a WiMAX network then the mobile station can identify a core network type (WiMAX network) associated with each of the core network listed in the MS. Then the MS can select NSP 104 (NSP_1) as the core network type of the NSP_1 is a WiMAX network.

In an embodiment, a SIM card 306 of the MS 112 will store the core network type of each core network. For example, core network types of the NSP 104, the NSP 106, the NSP 108 and the NSP 110 is stored in the SIM 306 of the mobile station 112.

The processor 304 in the mobile station 112 can select a core network based on the core network type of the plurality of core networks stored in the SIM 306. For example, when the MS 112 wants to connect to a WiMAX network then the mobile station can look up a core network type (WiMAX network) associated with each of the core network listed in the MS. Then the MS can select NSP 104 (NSP_1) as the core network type of the NSP_1 is a WiMAX network.

In an embodiment, the MS 112 also includes a transceiver 308. The transceiver 308 receives broadcasted or unicasted core network type information of each core network from the plurality of core networks associated with a NAP. Thereafter, the processor 304 in the MS 112 selects one core network type for enabling communication based on a preferred core network type. In an embodiment, the processor 304 selects one core type network based on a preferred communication protocol. Each core network is associated with a communication protocol that enables communication between mobile stations associated with the core network.

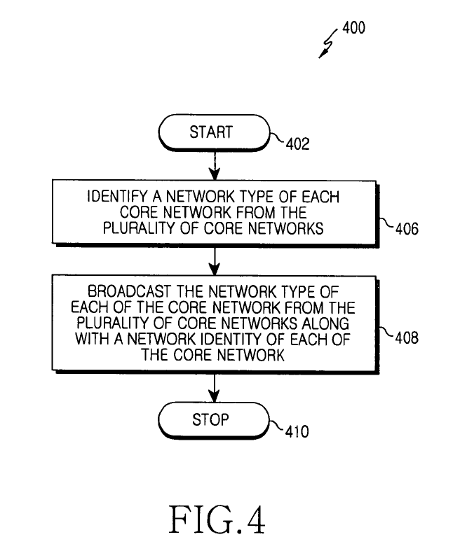

FIG. 4 illustrates a flow chart depicting a method 400 of managing information associated with a plurality of core networks associated with a network access provider in accordance with one embodiment of the present invention. To explain the method 400, references will be made to FIG. 1. However, it will be apparent to a person ordinarily skilled in the art that the present embodiment can be explained with the help of any other suitable embodiment of the present invention. The method 400 can also include more or fewer number of steps as depicted in FIG. 4. Further, the order of the steps may also vary. In an embodiment, the method is performed by the communication device.

At step 402 the method 400 is initiated. At step 404, the method identifies a core network type of each core network from the plurality of core networks. For example, the method identifies the core network types of the core networks 104, 106, 108, and 110 associated with the NAP 102. For example, the method identifies that the core network type of the core network 104 is WiMAX, the core network type of the core network 106 is Evolved Packet Core (EPC), the core network type of the core network 108 is HRPD, and the core network type of the core network 110 is EPC. In an embodiment, the NAP is a WiMAX network.

In an embodiment, the core network type information is a 3rd Generation Partnership Project (3GPP) network, a Non-3GPP network, a WiMAX network or a Non-WiMAX network. In another embodiment, the core network type information is a verbose name of the core network type associated with a core network. The verbose name of a core network type includes, but is not limited to, Worldwide interoperability for Microwave Access (WiMAX), Code Division Multiple Access (CDMA) 2000, Third Generation (3G) Network, Evolved Packet Core (EPC), Global System for Mobile communications (GSM), Universal Mobile Telecommunications System (UMTS), second-generation (2G), High Rate Packet Data (HRPD), and a System Architecture Evolution (SAE).

At step 408, the method broadcasts the core network type information associated with each core network from the plurality of core networks along with a network identity of each core network. For example, the method broadcasts NSP_1 WiMAX, NSP_2 EPC, NSP_3 HRDP, and NSP_4 EPC when the core network type of NSP_1 is WiMAX, the core network type of NSP_2 is EPC, the core network type of NSP_3 is HRDP and the core network type of NSP_4 is EPC, respectively. In an embodiment, the method broadcasts network information associated each core network from a plurality of networks based on a preferred core network list. The preferred core network list includes core network type information along with the core network information in an ascending or descending order of preference.

In an embodiment, the core network type information is broadcasted using an Over-The Air (OTA) broadcast message. In another embodiment, the core network type information is sent in a Service Identity Information (SII-ADV) message, an S-SFH Sub-packet 2 (SP2) message, an S-SFH Sub-packet 3 (SP3) message, a corresponding message in IEEE 802.16m standard or an Advanced Air Interface Service Identity Information (AAI_SII-ADV) message. In an embodiment, the core network type can be identified using an OID (NSP ID). In an embodiment, the core network type can be intimated in an SII-ADV and/or SBC-RSP message using NSP list TLV. The NSP list TLV description is provided in the table below. The network service provider type can be intimated in value column of a broadcast message.

| Name | Type | Length | Value | Scope |
|---|---|---|---|---|
| NSP List TLV | 140 | 4 * n | Including n, 24 bit | SBC-RSP, |
| | | | Network Service | SII-ADV, |
| | | | Provider IDs, 8 bit | SP2, SP3, |
| | | | Network Service | AAI_SII-ADV |
| | | | Provider type, n is | |
| | | | greater than or equal | |
| | | | to 1. | |

In an embodiment, a broadcast message can be an SP2 or AAI_SII-ADV message in 802.16m. In an embodiment, a unicast message can be an SS Basic Capability Response (SBC-RSP) message, an Advanced Air Interface SS Basic Capability Response (AAI_SBC-RSP) message, or a corresponding message in IEEE 802.16m standard.

In an embodiment, the core network type information can be intimated in an SII-ADV and/or SBC-RSP message using Verbose list TLV. In an embodiment, the Verbose NSP Name List is a compound list of the verbose names of the Network Service Providers (core networks) as indicated by the NSP List. The NSP List for verbose name is explained in the table below.

| Name | Type | Length | Value | Scope |
|---|---|---|---|---|
| Verbose | 139 | variable | List of verbose names of | SBC-RSP, |
| NSP | | | the Network Service | SII-ADV, SP2, |
| Name List | | | Provider(s) and NSP type. | SP3, |
| | | | The value of Verbose NSP | AAI_SII-ADV |
| | | | Name List is a compound | |
| | | | list of verbose NSP name | |
| | | | lengths and verbose NSP | |
| | | | names & NSP type. The | |
| | | | order of the Verbose NSP | |
| | | | Name Lengths and Verbose | |
| | | | NSP Names & NSP type | |
| | | | presented in the Verbose | |
| | | | NSP Name List TLV shall | |
| | | | be in the same order as the | |
| | | | NSP IDs presented in the | |
| | | | NSP List TLV. | |

In an embodiment, a broadcast message can be an SP2 or AAI_SII-ADV message in 802.16m. In an embodiment, a unicast message can be an SBC-RSP, an AAI_SBC-RSP or a corresponding message in 802.16m.

In an embodiment, the method 400 can unicast core network type information of each core network in a core network realm part, a network authentication message, or a Handover (HO) command message. For example, the MS can have a list of NSPs listed in its configuration. The NSP-IDs are mapped to a pre-assigned core network type by using configuration information in the MS. The indication of a core network type in an NSP ID is pre-configured in the MS or a SIM card associated with the MS.

The MS can retrieve core network type parameter in order to apply or adopt core network type specific procedures and mechanisms from the realm part received from the NAP. Hence, a core network type can be identified using the network realm part. For example, a core network type “epc” can be identified from “<user identity>@epc.WiMAXinterwork.network.org”, a core network type “WiMAX” is identified from “<user identity>@WiMAX.i-network.com” and a core network type “CDMA2000” can be identified from “<user identity>@cdma2000.i-network.org”. In an embodiment, the indication of a core network type in an NSP ID is pre-configured in the MS or a SIM card associated with the MS.

The core network type can also be unicasted during a network authentication procedure. For example, when an MS starts authentication procedures, the core network type information can be unicasted to the MS by the NAP. For example, the core network type information can be received by the MS in a Request/Identity function. For example, the core network type information can be received as an attribute in an EAP-Request/Identity (AT_CORE_NETWORK_TYPE). In another example, the core network type information can be included as an attribute in an EAP-Request/AKA-Challenge message during authentication.

In an embodiment, the value field of this attribute begins with the 2-byte that mentions core network type length. The core network type length identifies the exact length of the core network type in bits. The core network type length is followed by the core network type parameters in the attributes. In another embodiment, the core network type information can also be unicasted during Handover (HO) procedure. Hence, when an MS moves from one network to another, the NAP can unicast core network type information during HO procedures.

In an embodiment, a mobile station, for example the MS 112, receives core network type information sent by the NAP. Thereafter, the MS selects a core network from the plurality of core networks for enabling communication based on the received core network type information and preferred core network type information that is associated with the mobile station. At step 410, the method is terminated.

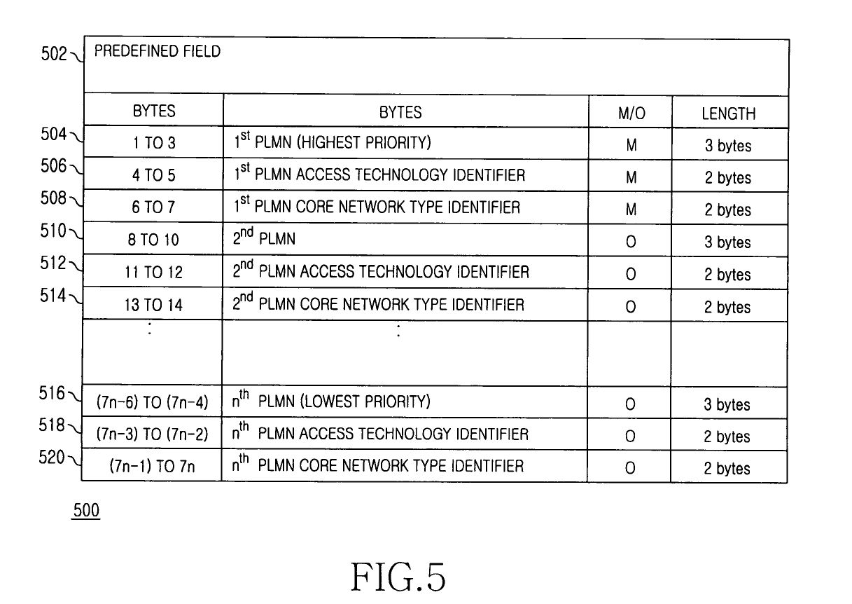

FIG. 5 illustrates an exemplary format 500 for storing information associated with core networks in accordance with one embodiment of the present invention. To explain the format 500, references will be made to FIG. 1. However, it will be apparent to a person ordinarily skilled in the art that the present embodiment can be explained with the help of any other suitable embodiment of the present invention.

In an embodiment, the core network type information of each core network from one or more plurality of networks is stored in a memory of a mobile station, for example, the memory 302 of the mobile station 112. In another embodiment, the core network type information of each core network from one or more plurality of networks is stored in a Subscriber Identification Module (SIM) card of a mobile station. For example, the SIM card 306 of the mobile station 112. Hence, the core network type information of each core network can be stored in a memory associated with MS or a SIM card associated with the MS.

in an embodiment, the core network type information is stored and pre-configured in the memory or a SIM card of the MS in an elementary format as shown in FIG. 5. The field 502 is associated with pre-defined fields. The field 502 can be associated with different attributes of the communication. For example, the field 502 can be divided into further sub fields. The sub fields are, for example, ‘Identifier’, ‘Structure’, ‘File Size’, ‘Update Activity’, ‘Access Conditions’ and the like. Further, information associated with different core networks can be pre-configured using fields 504 to field 520. For example, when there is ‘n’ number of core networks available then the information associated with the each of the core network that is from 1^{st} core network to ‘n^{th}’ core network can be stored in a format as shown in the format 500.

In the format 500, a field 504 stores Public Land Mobile Network (PLMN) priority information associated with the 1^{st} core network. A field 506 stores the PLMN access technology identifier of the 1^{st} core network. A field 508 stores the PLMN core network type identifier. Hence, information associated with one core network can be stored using seven bytes. For example, first 3 bytes (byte 1 to byte 3) will store core network information related to priority of access networks, the next two bytes (byte 4 and byte 5) can be used to store the access technology identifier of the core network, and in the next two bytes (byte 6 and byte 7), the core network type identifier can be stored.

Accordingly, information associated with each core network can be stored in the memory and/or SIM card of an MS. For example, the information associated with the second core network can be stored in a field 510, a field 512, and a field 514 using the bytes 8 to byte 14. Similarly, the n^{th} core network information can be stored in a field 516, a field 518, and a field 520 using the bytes ‘7n-6’ to byte ‘7n’.

In an embodiment, only PLMN name based on the priority and core network type is stored in the memory and/or SIM card of an MS. For example, the information associated with the access technology identifier associated with each core network can be excluded. For example, the field 506, the field 512 and the field 518 can be excluded. Hence, information associated with each core network will be PLMN information and its corresponding core network type information. Hence, the information can be stored using only 5 bytes.

In an embodiment, only information associated with core network type of each core network can be stored. Hence, the fields associated with PLMN and the access technology identifier can be excluded from storing. Therefore, in such an embodiment, the core network type information will only require 2 bytes field for storing the core network type information for each core network. Hence, only the field 508, the field 514 and the field 520 are stored in the memory or SIM card of an MS. Hence, a MS can select a core network based on the core network type information available in the MS.

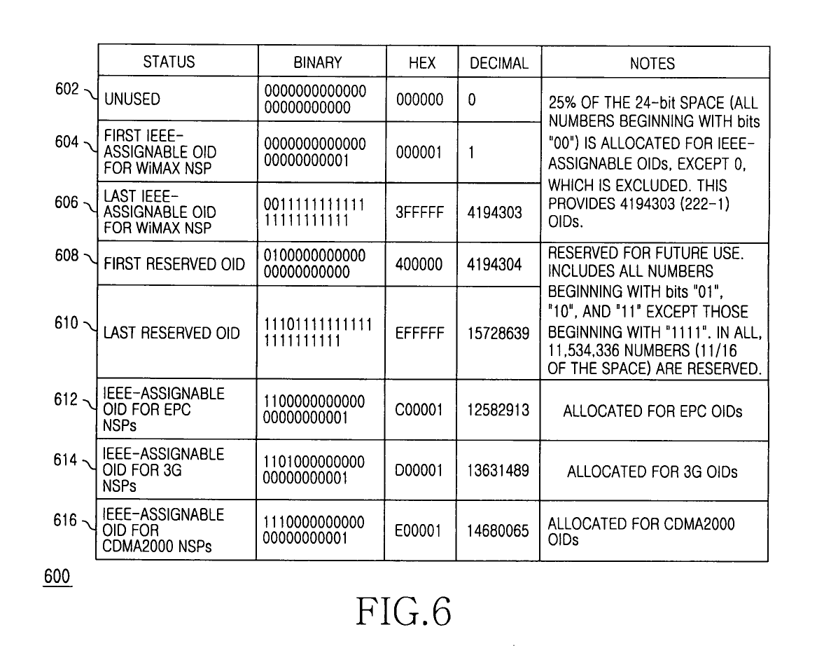

FIG. 6 illustrates an exemplary assignment of operator identity (OID) in one embodiment of the present invention. In an embodiment, different network can be identified using the OID. A format 600 represents an OID format that identifies network information using eight fields, for example field 602 to field 616.

A field 602 is the field that is unused by IEEE standards. The information associated with the WiMAX core network type can be stored in a field 604 and a field 606. Hence, a predefined setting of bit fields can be used to indicate whether a core network type is a WiMAX network type or not. A field 608 and a field 610 are first reserved OID field and last reserved OID field, respectively, as defined by the IEEE standards. A field 612 can be used to identify an Evolved Packet Core (EPC) network type. The one or more bits represented in this field can be used to indicate that a network type is associated with an ‘EPC’ core network. For example, a number that begins with bits “1100” in the field 612 will indicate EPC NSPs.

A field 614 represents a 3G network. Hence one or more bits in this field can be used to indicate that a core network type is associated with a ‘3G’ core network. For example, a number that begins with bits “1101” will indicate 3G NSPs. A field 616 represents CDMA 2000 NSPs. Therefore, one or more bits in this field can be used to indicate that the core network type is associated with a ‘CDMA 2000’ core network. For example, a number that begins with bits “1110” in this field can represent CDMA2000 NSPs. Similarly, only two bits can also be used to identify the core network types. For example, all numbers beginning with bits “01” in the field 612 represents ‘EPC’ NSPs, all numbers beginning with bits “10” in the field 614 represents 3G NSPs, and all numbers beginning with bits “11” in the field 616 represents CDMA2000 NSPs.

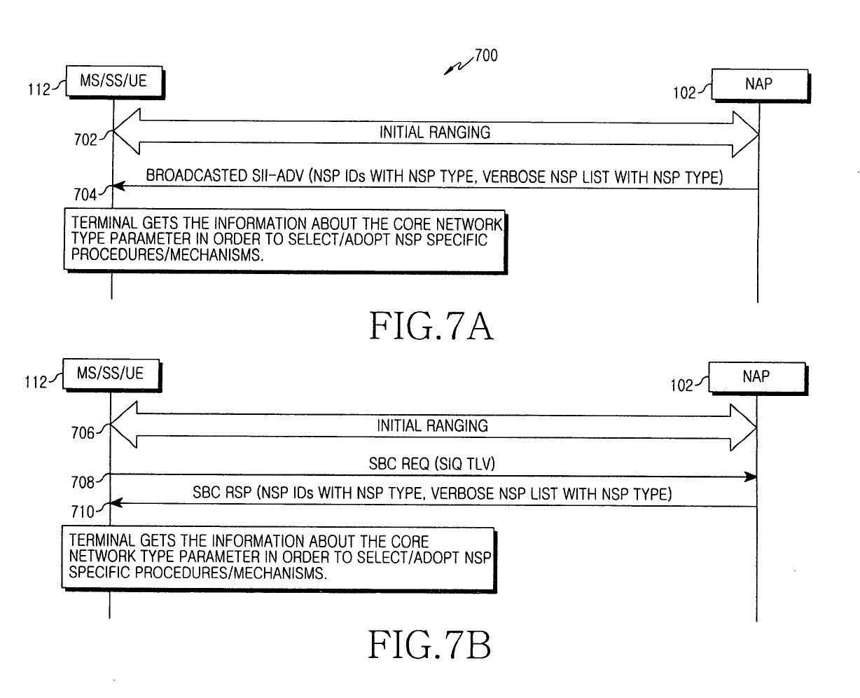

FIGS. 7A and 7B illustrate a call flow diagram representing a method of sending core network type information in accordance with one embodiment of the present invention. To explain the method 700, references will be made to FIG. 1. However, it will be apparent to a person ordinarily skilled in the art that the present embodiment can be explained with the help of any other suitable embodiment of the present invention.

At step 702 in the FIG. 7A, initial ranging between a Mobile Station (MS) and a Network Access Provider (NAP) is initiated. For example, initial ranging between the MS 112 and the NAP 102 is initiated. At step 704, the NAP 102 broadcasts or unicasts core network type information associated with each core network from a plurality of core networks. In an embodiment, the core network type information is broadcasted in a Service Identity Information (SII-ADV) message. The SII-ADV message includes parameters associated with core network types and/or verbose name of core network types. Further, the broadcasted information is received by the MS 112. Hence, a terminal, for example the MS 112, will get information about a core network type parameter. Further, the MS 112 can select or adopt selected core network type specific procedures and mechanism for enabling communication.

In FIG. 7B initial ranging between the MS 112 and the NAP 102 takes place at step 706. At step 708, the MS 112 sends a request to the NAP 102 for a core network type information. In an embodiment, the MS 112 can send the request using an SS Basic Capability Response (SBC-REQ (TLV)) message. Thereafter, at step 710, the NAP 102 sends a response message containing core network type information. In an embodiment, the NAP 102 sends an SBC-RSP message along with parameters associated with core network types and/or verbose names of core network types. Further, the MS 112 can select or adopt selected core network type specific procedures and mechanism for enabling communication.

Various embodiments of the present invention described above provide the following advantages. The present invention provides a method for managing core network type information when an access network is being shared by different core networks. The method broadcasts information associated with a core network type of one or more core networks. Then method also stores core network type information of each core network in a memory and/or a SIM card of the Mobile Station (MS). Hence, the MS can easily identify and select a preferred core network based on core network type information. The method reduces time in identifying a core network that is associated with a preferred core network type as the information is already available with the MS.

The method is also helpful in roaming when a mobile station needs to recognize a visited core network. The MS during roaming can easily identify the core network type of each core network as the information is either received from the NAP or the information is already stored in a memory and/or a SIM card of the MS. Thereafter, the MS can select a preferred core network. Thus, the MS does not have to access all the listed network service providers (NSPs) first and select a core network later. Thus, the preferred visited core network can be selected accurately without a trail and error mechanism. This increases battery life of the MS as the MS does not have to perform trial and error mechanisms for selecting the core network. Further, the method increases efficiency of the overall communication system.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for managing information of a plurality of core networks associated with a network access provider, the method comprising:
identifying a core network type of each core network of the plurality of core networks; and
broadcasting the core network type of each core network of the plurality of core networks along with a network identity of each core network.

2. The method of claim 1,.wherein the network access provider is a WiMAX network.

3. The method of claim 1, wherein the core network type information is at least one of a 3rd Generation Partnership Project (3GPP) network, a Non-3GPP network, a Worldwide interoperability for Microwave Access (WiMAX) network, a Non-WiMAX network, Code Division Multiple Access (CDMA) 2000, Third Generation (3G) Network, Evolved Packet Core (EPC), System Architecture Evolution (SAE) Global System for Mobile communications (GSM), Universal Mobile Telecommunications System (UMTS), second-generation (2G) and High Rate Packet Data (HRPD).

4. The method of claim 1, wherein broadcasting the core network type comprises sending a verbose name of the core network type associated with each core network of the plurality of core networks, wherein the verbose name of the core network type is at least one of a Worldwide interoperability for Microwave Access (WiMAX), Code Division Multiple Access (CDMA) 2000, Third Generation (3G) Network, Evolved Packet Core (EPC), System Architecture Evolution (SAE) Global System for Mobile communications (GSM), Universal Mobile Telecommunications System (UMTS), second-generation (2G) and High Rate Packet Data (HRPD).

5. The method of claim 1 further comprising broadcasting a preferred list of the core networks along with the core network type of each core network.

6. The method of claim 1, wherein broadcasting the core network type comprises sending the core network type information using an Over-The-Air (OTA) broadcast message.

7. The method of claim 6, wherein sending the core network type using an Over-The-Air (OTA) broadcast message comprises transmitting core network type information in at least one of an SII-ADV message, a Service Identity Information (SII-ADV) message, an S-SFH Sub-packet 2 (SP2) message, an S-SFH Sub-packet 3 (SP3) message, a corresponding message in IEEE 802.16m standard, and an Advanced Air Interface Service Identity Information (AAI_SII-ADV) message.

8. A method for managing information of a plurality of core networks associated with a network access provider, the method comprising:
identifying a core network type of each core network of the plurality of core networks; and
unicasting the core network type of each core network of the plurality of core networks in at least one of a core network realm part, a network authentication message, an SS Basic Capability Response (SBC-RSP) message, an Advanced Air Interface SS Basic Capability Response (AAI_SBC-RSP) message, a corresponding message in IEEE 802.16m standard, an OTA message to configure and update preferred network list, and a Handover (HO) command message.

9. A method for managing information of a plurality of core networks associated with a network access provider, the method at a mobile station comprising:
receiving information associated with a core network type of each core network of the plurality of core networks; and
selecting a core network from the plurality of core networks for enabling communication based on the received core network type information and a preferred core network type information that is associated with the mobile station.

10. A method for managing information of a plurality of core networks associated with a network access provider, the method at a mobile station comprising:
storing a core network type of each core network of the plurality of core networks in a memory associated with the mobile station; and
selecting a core network based on the core network type of the plurality of core networks.

11. A method for managing information of a plurality of core networks associated with a network access provider, the method comprising:
storing a core network type of each core network of the plurality of core networks in a Subscriber Identification Module (SIM) card memory, wherein the SIM card is associated with the mobile station; and
selecting a core network based on the core network type of the plurality of core networks.

12. A network access provider comprising:
a processor to identify a core network type of each core network of a plurality of core networks associated with the network access provider; and
a transceiver to transmit the core network type of each core network of the plurality of core networks along with a network identity of each core network.

13. A mobile station comprising:
a memory configured to store a core network type of each core network of a plurality of core networks in a memory associated with the mobile station; and
a processor configured to select a core network based on the core network type of the plurality of core networks.

14. The mobile station of claim 13, wherein the core network type is at least one of a 3rd Generation Partnership Project (3GPP) network, a Non-3GPP network, a Worldwide interoperability for Microwave Access (WiMAX) network, a Non-WiMAX network, Code Division Multiple Access (CDMA) 2000, Third Generation (3G) Network, Evolved Packet Core (EPC), System Architecture Evolution (SAE) Global System for Mobile communications (GSM), Universal Mobile Telecommunications System (UMTS), second-generation (2G) and High Rate Packet Data (HRPD).

15. The mobile station of claim 13, wherein the core network type comprises a verbose name of the core network type associated with each core network of the plurality of core networks, wherein the verbose name of the core network type is at least one of a Worldwide interoperability for Microwave Access (WiMAX), Code Division Multiple Access (CDMA) 2000, Third Generation (3G) Network, Evolved Packet Core (EPC), System Architecture Evolution (SAE) Global System for Mobile communications (GSM), Universal Mobile Telecommunications System (UMTS), second-generation (2G) and High Rate Packet Data (HRPD).

16. The mobile station of claim 13 further comprising a receiver configured to receive a preferred list of the core networks along with the core network type of each core network.

17. The mobile station of claim 13, wherein the core network type is received in an Over-The-Air (OTA) broadcast message.

18. The mobile station of claim 13, wherein the core network type is received in at least one of an SII-ADV message, a Service Identity Information (SII-ADV) message, an S-SFH Sub-packet 2 (SP2) message, an S-SFH Sub-packet 3 (SP3) message, a corresponding message in IEEE 802.16m standard, and an Advanced Air Interface Service Identity Information (AAI_SII-ADV) message.

19. The mobile station of claim 13, wherein the core network type of each core network of the plurality of core networks is received from a network access provider.

20. The mobile station of claim 19, wherein the network access provider is a WiMAX network.
